(19) United States
(12) Patent Application Publication
(10) Pub. No.: US 2023/0136496 A1
(43) Pub. Date: May 4, 2023

(54) LIQUID DRINK AND PRODUCTION METHOD

(71) Applicant: DOYURAN GRUP GIDA VE SÜT ÜRUNLERI ÜRETIM SANAYI LIMITED SIRKETI, Sincan, Ankara (TR)

(72) Inventor: Ahmet ERSOY, Sincan, Ankara (TR)

(21) Appl. No.: 17/928,321

(22) PCT Filed: Jul. 13, 2020
(86) PCT No.: PCT/TR2020/050619

§ 371 Date: Nov. 29, 2022

(30) Foreign Application Priority Data
Jun. 5, 2020 (TR) 2020/08708

(51) Int. Cl. A23C 9/13; A23C 9/133

(52) U.S. Cl. CPC A23C 9/1315; A23C 9/1322; A23C 9/133

(57) ABSTRACT

The invention is about a beverage produced with vitamins, nutritious, filling, probiotic-strong, ready for direct consumption and has been developed to make the liquid beverage more useful, increasing the variety and taste, unlike standard beverage production in the food industry. In particular, the invention; relates to a ready-made liquid beverage that can contain a mixture of yogurt, water, flour, rice, chickpeas, eggs, spinach, parsley and optionally peppermint, dill, coriander and salt.

### TECHNICAL FIELD

The invention is about a beverage produced with vitamins, nutritious, filling, probiotic-strong, ready for direct consumption and has been developed to make the liquid beverage more useful, increasing the variety and taste, unlike standard beverage production in the food industry.

In particular, the invention; relates to a ready-made liquid beverage that can contain a mixture of yogurt, water, flour, rice, chickpeas, eggs, spinach, parsley and optionally peppermint, dill, coriander and salt.

### PREVIOUS TECHNIQUE

Today, there are many products that are rotated in the beverage industry. Harmful additives in existing beverages and their health disadvantages increase the tendency to consume additive-free natural healthy beverages. In addition, people's search for different tastes in instant drinks is also increasing. Competition between companies to meet this need in ready-to-drink beverages leads to the market of unhealthy products.

The consumption of fast-foods containing mainly carbohydrates that are harmful to health and used in the current technique is a major factor in the formation of obesity, diabetes, vitamin-freeness, cardiovascular diseases and unhealthy living conditions.

The content of instant drinks used in the current technique does not fully address the consumer.

Since the content of instant drinks used in the current technique is insufficient, the desired quality flavor cannot be provided to the consumer. Due to this situation, manufacturers resort to various flavoring additives.

The fact that a standard has been achieved in all beverage productions used in the current technique prevents product diversity and creates a competitive power only by brand. This situation causes the P&D studies to stop.

As a result; for the solution of the above-mentioned problems, a ready-made cooked cold drink containing healthy and natural nutrients was needed.

### PURPOSE OF THE INVENTION

The invention; relates to a ready-made liquid beverage that can contain a mixture of yogurt, water, flour, rice, chickpeas, eggs, spinach, parsley and optionally peppermint, dill, coriander and salt.

The object of the invention; is to offer a different and new taste to consumers who want to eat healthy at any time.

The main raw material of the invention is yogurt without additives, preservatives, skimmed milk and fermented using natural yeast. As is known, yogurt is a very strong probiotic store. Probiotics, which are natural armor against diseases in the body, have become increasingly important recently. Probiotics also help the digestive system to work well with peristaltic movements. It is a very important preventive health factor to gain these bacteria much more from outside, to open more space in the intestines and to increase their number as much as possible.

Conscious consumers strive for consuming nutritious and beneficial foods for both themselves and their children.

The beverage in the invention has the feature of liquid beverage produced industrially but prepared in a quality as if it is prepared in the kitchen of the consumer.

An object of the invention is that the product conforms to the definition of fast-food, but creates a completely natural and healthy food chain in terms of content.

The aim of the invention is to provide the food, which is difficult to be consumed alone in daily life, to the consumer in a practical way as a beverage. Thus, the consumer is fed with a mixture of low calorie but high nutritional value and lives a healthy life.

The object of the invention is to be an easy-to-consume instant beverage that can be preserved for a long time and served as a cold drink.

Another object of the invention; It combines nutrients that are beneficial in terms of health and ensures that these foods, which are difficult to consume in daily life, are cooked and presented as ready-to-drink.

The relevant invention will become a preferred product in the sector with its present form and simple structure. Thus, commercial success will be achieved and will contribute to the food industry with a healthy and different taste.

### DETAILED DESCRIPTION OF THE INVENTION

The invention relates to a beverage produced in the food industry with vitamins, nutritious, filling and probiotic-strong and ready for direct consumption.

Ready-made package beverage, the topic of the invention; relates to a ready-made liquid beverage that can contain a mixture of yogurt, water, flour, rice, chickpeas, eggs, spinach, parsley and optionally peppermint, dill, coriander and salt.

The invention is a liquid beverage containing yogurt, cereals and green vegetables. The invention will be offered in places such as school canteens, markets, camps, military, collective consumption etc.

In the production method of invention subject ready-made package cooked beverage; Firstly, mixing the flour and water, and mixing the yogurt and the egg are provided separately. Mixes of flour-water and yogurt-eggs, which are mixed separately, are mixed with each other. After this mixture, rice is cooked separately. Salt is added and mixed during cooking the rice. In this way, salt is provided to penetrate into the rice. The salt-rice mixture that emerges after this process is added to the flour, water, yogurt and egg mixture created earlier and the mixing process continues. After this step, spinach is added to the mixture of the invention. After adding the spinach, the final product is sent to the filling unit. Boiled chickpeas are added to the packaging of the liquid beverage before filling. With the addition of boiled chickpeas, the filling of the final product is ensured and the production is completed and the product is sent to the cold store. Preferably, also greens such as parsley, peppermint, dill, coriander can be added to the invention with spinach. Also, the addition of salt is provided optionally.

Another important issue in the invention is that the yogurt of the invention is in the homemade method and the yeast used is natural yeast.

The beverage containing these processing steps is preferably served cold to the consumer. However, the consumer will also be able to consume this beverage by heating slightly.

1. A beverage produced with vitamins, nutritious, filling, probiotic-strong, ready for direct consumption and has been developed to make the liquid beverage more useful, increasing the variety and taste, unlike standard beverage production in the food industry, including yogurt, water, flour, rice, eggs and spinach.

2. The beverage of claim 1 further including parsley to the said beverage content.

3. The beverage of claim 1 further including mint to the said beverage content.

4. The beverage of claim 1 further including dill to the said beverage content.

5. The beverage of claim 1 further including coriander to the said beverage content.

6. The beverage of claim 1 further including salt to the said beverage content in the rice cooking phase.

7. A method of producing beverages comprising:
mixing flour and water,
mixing yogurt and eggs in a separate area,
mixing of flour-water and yogurt-egg mixtures, which are mixed separately,
cooking rice separately,
adding and mixing the rice mixture to the flour, water, yogurt and egg mixture previously created,
sending the final product to the filling unit after this stage,
filling the liquid beverage into the packages and completing the production, process steps.

8. The beverage production method of claim 7 further including spinach to the mixture after the adding and mixing step of the rice mixture to the flour, water, yogurt and egg mixture previously formed.

9. The beverage production method of claim 7 further including boiled chickpeas to the packaging of the liquid beverage before filling.

10. The beverage production method of claim 7 further including parsley, mint, dill, coriander with spinach to the said beverage content.

11. The beverage production method of claim 7 further including salt during cooking rice to the said beverage content.

12. The beverage production method of claim 7 further including salt addition to the said beverage content, which is provided by penetrating the salt into the rice.
